(19) United States
(12) Patent Application Publication
(10) Pub. No.: US 2020/0342421 A1
(43) Pub. Date: Oct. 29, 2020

(54) HOME MAINTENANCE AND REPAIR INFORMATION TECHNOLOGY METHODS AND SYSTEMS

(71) Applicant: Super Home Inc., Danville, CA (US)

(72) Inventors: Jorey E. Ramer, Danville, CA (US); William M. Davis, Rockville, MD (US)

(21) Appl. No.: 16/960,481

(22) PCT Filed: Sep. 1, 2016
(86) PCT No.: PCT/US16/49844

§ 371 Date: Jul. 7, 2020

Related U.S. Application Data
(60) Provisional application No. 62/219,924, filed on Sep. 17, 2015.

(51) Int. Cl. G06Q 10/00; G06Q 30/02; G06Q 10/10; G06Q 30/00; G06Q 50/10

(52) U.S. Cl. CPC G06Q 10/20; G06Q 30/0283; G06Q 50/10; G06Q 30/0185; G06Q 30/016; G06Q 10/1093

(57) ABSTRACT

Provided herein are methods and systems for enabling a host provider to provide a consumer homeowner with improved maintenance and repair services for items in the home, including under a subscription model that provides the consumer with predictable cost while assuring reliable services.

### CROSS-REFERENCE TO RELATED APPLICATIONS

This application is a national stage entry application of International Patent Application No. PCT/US16/49844 filed on Sep. 1, 2016, which claims priority to U.S. Provisional Patent Application No. 62/219,924 filed on Sep. 17, 2015, where the entire contents of each are incorporated herein by reference in their entirety.

### TECHNICAL FIELD

This disclosure generally relates to the field of home repair and maintenance, and more particularly to methods and systems for facilitating long term repair and maintenance for consumer subscribers through a host company's use of information technology.

### BACKGROUND

A typical consumer's home contains or is made up of various structural elements, appliances, equipment, fixtures, furniture and the like, all of which are subject to potential problems and may be in need of repair from time to time. For most consumers, after a relatively short warranty expires on a given item, they are on their own to handle any potential repairs, often requiring them to call on service providers of uncertain quality, availability and value to make repairs, and exposing them to unpredictable patterns of expense. A need exists for methods and systems that improve the consumer experience, such as by assuring the provision of available, high quality services at fair prices and with predicable costs.

For providers of home maintenance and repair services, the information and systems needed to provide large scale, efficient services to thousands of consumers have been historically lacking. Information about what items are in the homes of various consumers, of what makes, models and vintages, has historically been located across a wide range of different sources, such as disparate companies that have sold appliances, installed equipment, or otherwise provided items to a particular consumer. Much of that information has not been available to anyone other than the consumer, and consumers have not typically cataloged such information in a way that is accessible to others. Similarly, data about experiences of consumers with service providers (such as maintenance workers and the like), and experiences of service providers with customers, has been limited to anecdotal information, or simple social network sites like Angie's List™ or ratings sites like Yelp™. A holistic view of different service providers, and in particular their relevancy to a given consumer homeowner, has been lacking. Similarly, integration and analysis of heterogeneous data sources, across many potentially relevant factors, has been challenging for technology developers. As increasing amounts of data are available about all of these factors, such as in the proliferation of data sources in a home as a result of emergence of the Internet of Things, and many other factors, a need exists for improved information technology and analytic systems that will enable improved outcomes for consumers and providers of home maintenance and repair services.

### SUMMARY

Provided herein are systems and methods for enabling a host organization to offer and support a subscription for a consumer that provides maintenance, preventative care, and repairs for the consumer's home. The host may use a range of data sources and structures, novel analytics, and various information technology elements to determine what resources should be used to provide services to the consumer, and the host pays for work to be done that is covered by the subscription. Services that may be provided may include HVAC, appliances (e.g., refrigerator, washer, dryer), electrical, plumbing, roofing, siding, foundation maintenance, and others.

Provided herein is an overall information technology system, with interrelated modules and components for enabling a host to facilitate provision of home maintenance and repair services to a consumer. The methods and systems disclosed herein may include an item scoring module for scoring at least one item based on its type, the score based at least in part on a probability of a need for maintenance or repair and the estimated cost of such maintenance or repair; a service provider scoring module for scoring at least one service provider based on at least one of the quality of maintenance or repairs provided by the service provider, the availability of the service provider, the reliability of the service provider and the cost of the service provider; and a pricing module for estimating the cost of providing a commitment to provide long term maintenance and repairs for the at least one scored item using at least one scored service provider. In embodiments, the pricing module may include a facility for determining at least one of a loss ratio, an administrative cost, a lifetime value, and a renewal rate. In embodiments, the pricing module may include a pricing analysis module. In embodiments, the methods and systems may include a consumer communication module, such as allowing communication to a consumer using various interfaces. The consumer communication module may include at least one of a scheduling module, a cost estimation module, a gamification module and a coordination module. The system may further include a service fulfillment module. In embodiments, the service fulfillment module may be used to select a service provider for fulfillment based at least in part on the service provider scoring module. In embodiments, the methods and systems may include a bad faith detection module for determining bad faith behavior on the part of at least one of a consumer and a service provider. In embodiments, the methods and systems may further include a service provider portal for facilitating interaction of a service provider with the system. In embodiments, the service provider portal may facilitate the provision of information to a service provider mobile application that provides information about repair or maintenance activities for a service provider with respect to at least one item of at least one consumer.

References to the “host” herein refer to a user of the information technology methods and systems described herein in order to provide home maintenance, repair and similar services with respect to various items, such as appliances, equipment and the like, on behalf of the owner of a home, such as a consumer. The host may be a company that provides such services to the consumer on a subscription basis, such as for a predetermined monthly or annual fee.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the systems and methods disclosed herein.

FIG. 1A illustrates an embodiment of an architecture, with various modules, for a system for enabling a host to provide improved repair and maintenance services to a consumer homeowner.

FIG. 1B illustrates a functional block diagram of various functions that are performed in the systems and methods described herein, including indications of information flows and interfaces among various functions.

FIG. 2 illustrates an embodiment of a pricing module, with various modules and sources, for a system for enabling a host to provide improved repair and maintenance services to a consumer homeowner.

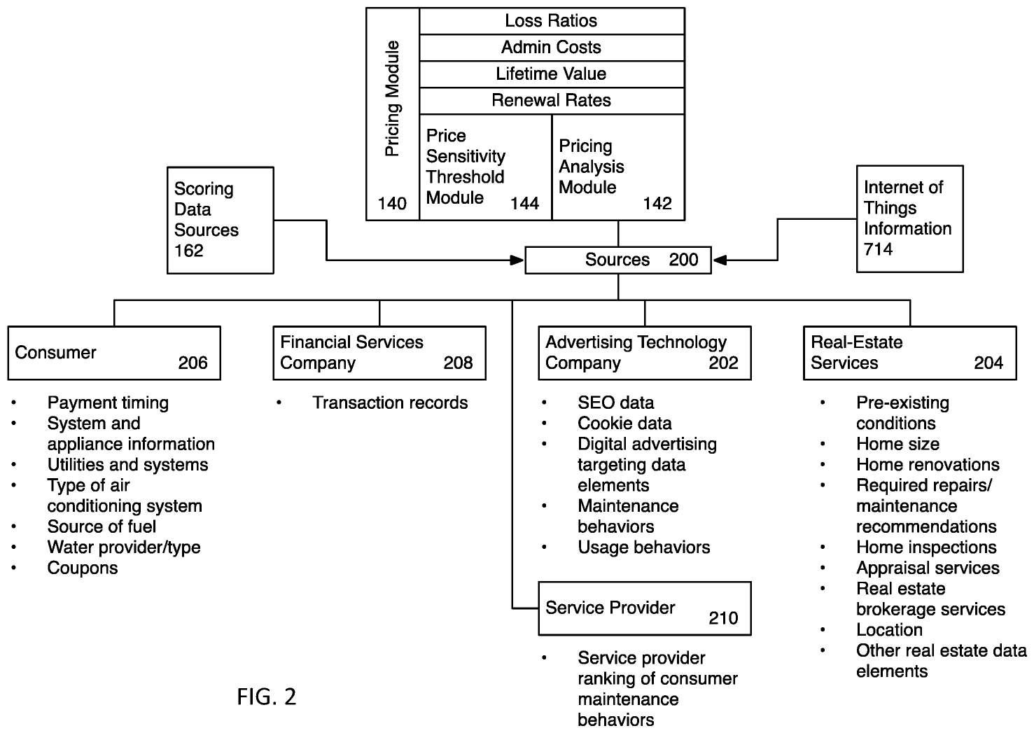

FIG. 3 illustrates an embodiment of a service fulfillment module, with various modules and sources, for a system for enabling a host to provide improved repair and maintenance services to a consumer homeowner.

FIG. 4 illustrates an embodiment of a service provider selection module, with various factors, for a system for enabling a host to provide improved repair and maintenance services to a consumer homeowner.

FIG. 5 illustrates an embodiment of a service provider portal, for a system for enabling a host to provide improved repair and maintenance services to a consumer homeowner.

FIG. 6 illustrates an embodiment of a service provider mobile app, for a system for enabling a host to provide improved repair and maintenance services to a consumer homeowner.

FIG. 7 illustrates an embodiment of a scoring module, with various scoring data sources, for a system for enabling a host to provide improved repair and maintenance services to a consumer homeowner.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the systems and methods disclosed herein.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art. The claims should be consulted to ascertain the true scope of the disclosure.

Before describing in detail embodiments that are in accordance with the systems and methods disclosed herein, it should be observed that embodiments include combinations of method steps and/or system components. Accordingly, the system components and method steps have been represented where appropriate by conventional symbols in the drawings, showing only those specific details that are pertinent to understanding the embodiments of the systems and methods disclosed herein so as not to obscure the disclosure with details that will be readily apparent to those of ordinary skill in the art having the benefit of the description herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms.

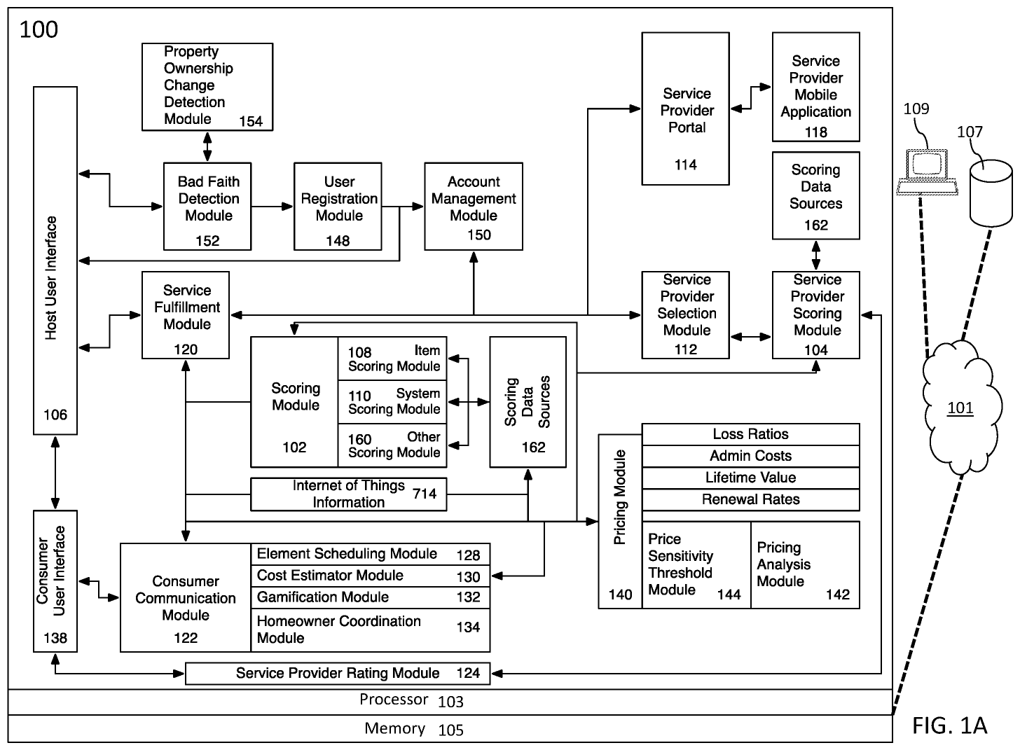

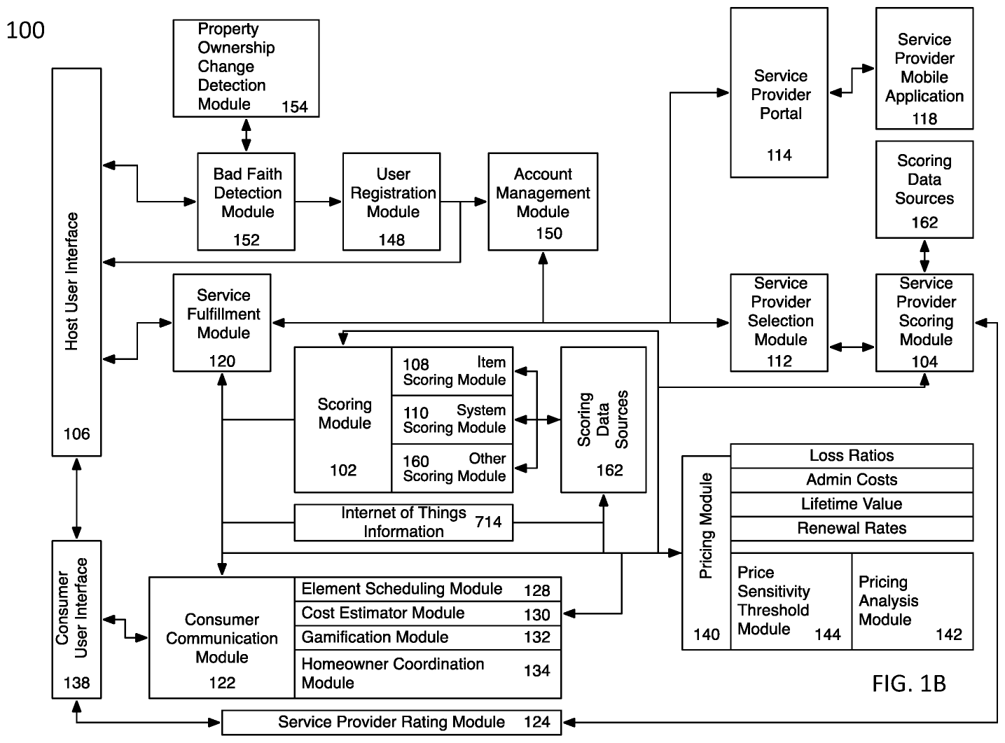

FIG. 1 illustrates a block diagram of major components of a system (referred to in some cases as the “host system”) for enabling a host to enable a consumer homeowner to obtain improved repair and maintenance services for various items in the home. In embodiments, consumers may pay a single price (monthly, annually, or the like) for a subscription that covers maintenance and repairs for a defined set of items and systems. As used herein, an “item,” “system,” “covered item,” or “covered system” may be understood to include various structures and systems of and around the home itself (e.g., roof, foundation, flooring, framing, windows, doors, walls, decks, patios, sidewalks, pools, spas, ceilings, plumbing, electrical systems, networks, etc.), furnishings (e.g., beds, couches, chairs, tables, lighting units, outdoor furniture, etc.), appliances/equipment (e.g., refrigerators, televisions, sound systems, home automation systems, stoves, dishwashers, washing machines, clothes dryers, ovens, vacuum cleaners, blenders, mixers, juicers, toasters, power tools, etc.), and other items that may need maintenance or repair over time. References and examples throughout this disclosure to particular items should be understood to encompass any other items or types of items, except where context indicates otherwise.

Referring to FIG. 1A, the functional modules of a host system 100 may employ various information technology elements, such as CPUs, memory, servers, networking and communications facilities, databases, and the like. The various modules may be deployed on the premises of the host or in the cloud, and may access local or distributed data sources, such as over one or more networks 101. The host system 100 may have a host user interface 106, which may be a single, integrated interface for multiple modules or may comprise various distinct interfaces for the various modules described herein. The various user interfaces described herein may be embodied on personal or laptop computers (including via web applications in a browser), notebooks, tablets, or smartphones (including via mobile applications downloaded on the user device or via a mobile browser). The host system 100 may include a wide range of modules that enable the host to facilitate provision of reliable home maintenance and repair services for a pre-determined price, such as delivered according to a subscription. The modules may include a scoring module 102, which may involve a service provider scoring module 104, an item scoring module 108, and a system scoring module 110. The modules may also include a service provider selection module 112, a service provider portal 114, a service provider mobile application 118, and a service fulfillment module 120. Service providers may rate the consumers to which they supply services via the mobile application 118 and/or portal 114. The modules may include a consumer communication module 122, which may include an element scheduling module 128, a cost estimator module 130, a gamification module 132 and a homeowner coordination module 134, one or more of which may populate information accessed by a consumer, such as through a consumer user interface 138. The consumer user interface may include a service provider rating module 124, which may facilitate taking input from consumers about particular service providers (such as on time arrival, quality of work, friendliness and the like), which may be used as input to the service provider scoring module 104. Service providers may include parties performing actual maintenance and repair services (either at the home or at remote repair locations), as well as parties that provide warranties, extended warranties, insurance, and other contracts and instruments, such as with respect to particular items. The system 100 may also include a pricing module 140, which may comprise a multi-vector pricing module, which may ingest, clean, normalize, process and analyze information about items, information about service providers, information about other factors (such as macroeconomic data) and the like and may include facilities for analyzing loss ratios, administrative costs, lifetime value of a consumer subscription, renewal rates and the like. The pricing module 140 may include a pricing analysis module 142, which may include or work in coordination with a price sensitivity threshold module 144. The host system 100 may further include a user registration module 148 and an account management module 150. The host system 100 may also include a bad faith detection module 152, which may include or coordinate with a property ownership change detection module 154. The various modules may obtain data from a wide range of sources, such as the other modules and external data sources, such as sources relating to types of items, maintenance and repair history data sources, service provider listings and ratings, economic data (such as anticipated inflation rates and interest rates), warranty information (including extended warranty information) and the like. As more and more items become enabled with processors and communication facilities (such as in the Internet of Things (TOT)), information may be collected directly from the items or from databases that aggregate information published by or about such items. While FIG. 1A shows the various modules on a single system, with a processor 103 and memory 105, optionally deployed in the cloud, such as via a server, and connected to remote databases 107 and computing systems 109, such as via networks 101, it should be understood that the modules and components could be arranged in a wide variety of configurations, distributed across different computing systems and the like, in accordance with various specific embodiments. The functional diagram of FIG. 1B, should be understood to indicate connections and interfaces among the various modules, such as for the transmissions of outputs from a given module that serve as inputs to the other modules. These connections may be network connections or may be accomplished by other mechanisms, such as over an information bus of a dedicated system. The connections may be achieved by software or middleware interfaces, by the use of application programming interfaces (APIs), by data integration systems (such as for extraction, transformation, transport and loading of information between systems having distinct data types and using distinct protocols), and by the use of services, such as in services oriented architectures. Each of these approaches may solve problems noted above, in particular the fact that data has historically been unavailable, or spread across so many distinct sources that it has been a practical impossibility for a single service provider to perform the kinds of analysis required to ensure effective matching of service providers to homeowners, to ensure consistent and efficient repairs and to perform accurate cost estimation and pricing analysis.

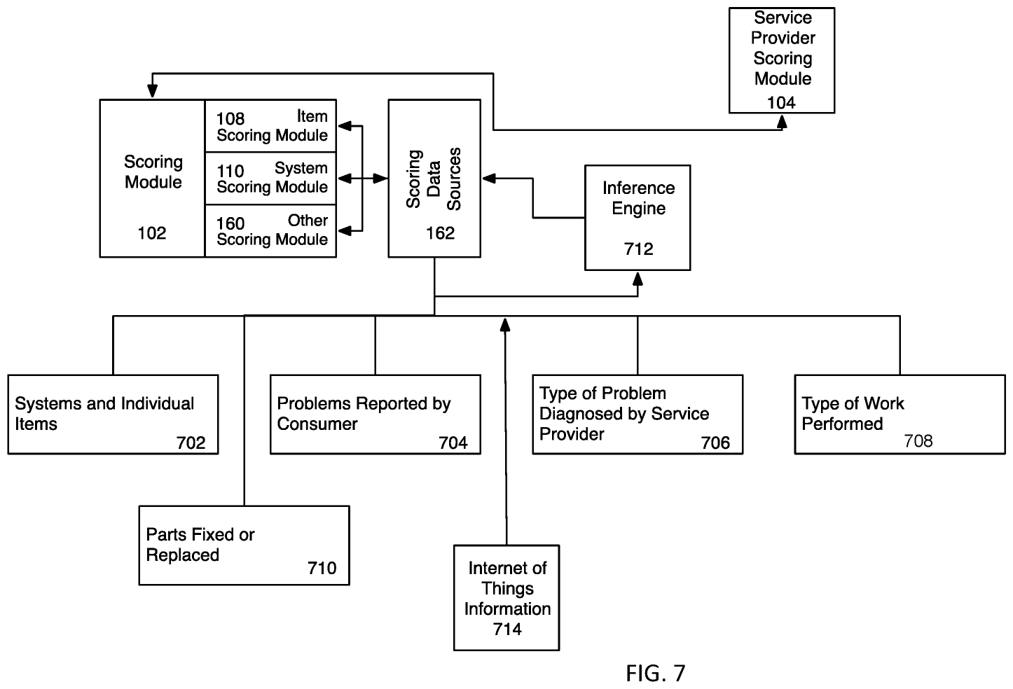

The modules of the host system 100 may include the scoring module 102 for scoring various items based on various available data sources. Scoring may involve the service provider scoring module 104, the item scoring module 108, the system scoring module 110, other scoring module 160 and the like. Referring to FIG. 7, with respect to the item scoring module 108, system scoring module 110 and other scoring module 160, the host system 100 may collect information from scoring data sources 162 that indicates the systems (e.g., HVAC) and individual items 702 such as appliances in or around the home, such as the make, model, serial number, age and the like. In embodiments, this information may be collected directly from the items themselves, such as for IOT-enabled items that connect to the Internet and can indicate their presence, type, age, current condition and the like directly to the host system 100 or to any of the scoring data sources 162 that are used by the host system 100. The host system 100 may also facilitate collection of information from scoring data sources 162 on the problems reported by the consumer 704, the type of problem diagnosed by the service provider 706, the type of work performed 708, and the different types of parts fixed or replaced 710 for each item or system. Once this information is collected, an overall quality score can be provided, or a sub-component score, using these various information sources, such as via the scoring module 102. With respect to the service provider scoring module 104, outcomes can be tracked to provide a service provider score that is based at least in part on the items and systems of a consumer's home. Commonly, quality scores in the industry have no segmentation. For example, ratings sites like Yelp or sites like Angie's List might give four stars to a service provider, but as a simple example, that service provider might be good at GE repair but bad at Viking repair. Tracking outcomes that relate to particular items and systems may facilitate more accurate scoring, including rating a service provider with respect to competencies that are specific to the items or systems of a particular consumer's home.

Where specific data about items in a home is absent, the host system 102 may also infer the presence, type, age and/or condition of certain items, such as using an inference engine 712, which may be a rules engine or the like that may take as inputs various data sources, such as the ones used as scoring data sources 162 and may also provide inferences that serve as scoring data sources 162. For example, an inference engine 712 may infer that a home is very likely to have certain kinds of items, such as a heating system, an oven, and a refrigerator, notwithstanding the absence of specific information. The inference engine 712 may infer the age of items, such as inferring that for a home that is less than ten years old, the heating system is likely to have the same age as the home itself. The inference engine 712 may also infer the likely type of items, such as by using information from advertising data providers that indicate the most popular items in a particular region or information from other sources that indicate the favorite brands of a homeowner, such as based on the brands of other items owned by the homeowner (e.g., a BMW owner might be inferred to have a Viking™ stove in the absence of specific information, or the owner of an Amana™ stove might be assumed to own an Amana™ microwave oven). The inference engine 712 may be a simple rules engine, may apply various technologies for matching and correlation, including fuzzy matching, and may employ machine learning, such as to improve inferences based on outcomes of past situations. For example, inferences used to estimate the cost of a subscription to the host and to set the price in the pricing module 140 can be confirmed, or determined to be false, during the process of performing maintenance and repairs, such as by having a service provider or consumer log information about the actual items in the home, which can be compared to the inferences and, over time, used to improve the performance of the inference engine 712.

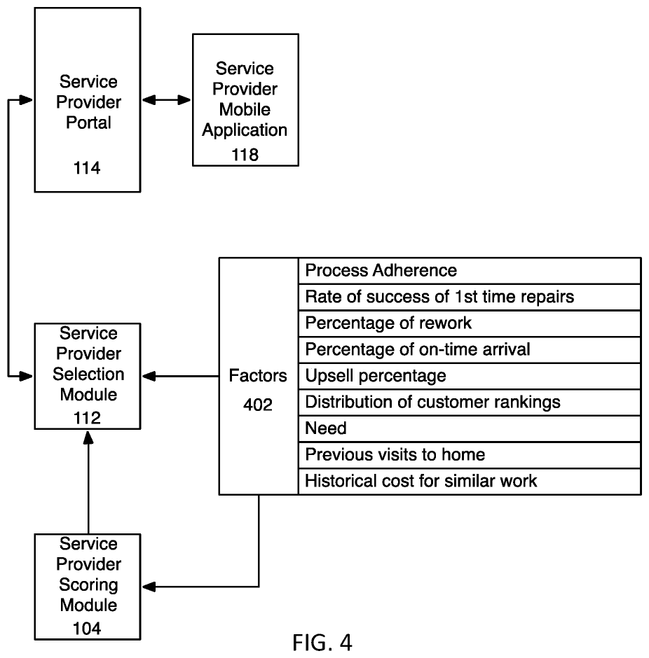

The modules of the host system 100 may also include a service provider selection module 112, a service provider portal 114, and a service provider mobile application 118. Selection of the service provider for a home maintenance or repair today is based primarily either on the cost or based on a pre-existing relationship (such as when the consumer turns to the same company that sold an appliance to provide a repair, even after a warranty period has expired). The problem is that these factors tend to drive down quality to a minimum standard (or perhaps below what should be the minimum standard). While some parties have started to look at quality as a selection criteria, the data collected by such parties is typically minimal. The host of the methods and systems disclosed herein can facilitate a very accurate quality score by requiring that a score or rating be captured by a consumer before the consumer can perform any other function, so that the host system 100 can have a very high percentage of quality scores. Referring to FIG. 4, beyond cost and quality, much more sophisticated selection criteria may be used in the service provider selection module 112, including one or more factors 402 relating to process adherence 404, the rate of success of first time repairs 406, the percentage of rework 408, the percentage of on-time arrival 410, upsell percentage 412, the distribution of customer rankings 414, need 416, previous visits to the home 418, and historical cost for similar work 420. For example, with respect to process adherence, the system can consider whether the service provider has used the process that the host has requested. For example, for appliance repair, the host may request that the service provider do a triage call before going on-site. In the triage call, the service provider would determine what the problem was so that the service provider can collect a part from a parts distributor before going on-site. Such a process has a significant effect on first time fix rates (meaning the number of times a service provider can fix the problem on a first call without returning for a second call). The host of the system 100 can determine if a service provider was abiding by a defined process because the host system 100 may provide the service provider with a mobile website or application 118 where the service provider will report on the process steps in real-time. If the host observes unusual behaviors (e.g., the service provider clicks on all the steps completed all at once), then the host can know that the service provider is not properly reporting on the progress. In general, to obtain high quality ratings, a service provider would have a high first time fix rate and correspondingly low rework percentage. As to on-time arrival percentage, the host system 100 may solicit information about arrival from consumers and service providers and track the percentage of times the service provider arrived on-site at the appointment time or within the appointment window. A high quality rating would seek a high percentage of on time arrival. As to upsell percentage, the host may collect information and track whether the service provider was able to upsell additional products and services. As to distribution of customer rankings, the host may determine whether the service provider seems to have less patience for consumers based on the distribution of ratings of the consumer as compared to ratings of the same consumer by other service providers. As to need, the system may determine whether a particular customer that can tolerate a lower quality service providers or requires only those of the highest and/or may determine whether a particular customer is approaching a renewal date, where a higher quality service provider could increase the likelihood of renewal. Similarly, the host system 100 may determine whether a particular consumer is a long-time customer that is unlikely to drop, or a customer that complains frequently and requires a higher quality service. As to previous on-site visits, the host system 100 may determine whether a particular service provider was previously on-site at a consumer's location, whether the consumer expressed a preference or need for the same service provider, and whether a customer is approaching their renewal date, where the same service provider would be appreciated and therefore increase likelihood of renewal. As to historical cost, data may be collected and analysis performed as to similar work done, such as with the same or similar makes and models, type of problems, types of repairs, age of products and the like. Service provider selection via the selection module 112 may account for these factors in various ways, such as by taking a simple score from the service provider scoring module 104 (which may account for various factors 402 relating to the service provider, as well as a wide range of other factors and vectors noted throughout this disclosure), using other scores from the scoring module 104, applying one or more of the factors 402 directly to achieve selection (such as where a consumer has indicated a strong preference for a familiar provider, in which case weighting of a factor like previous visits to the home 418 may be increased, or made a determining factor), or applying a matching process, such as a fuzzy matching process or a matching process based on similarity (such as matching based on a metric of similarity, given a service provider's competencies with various items, such as particular brands of appliances, with the mix of items in a consumer's home, to find the service provider that, in the absence of a perfect fit, has the best match of competencies to the consumer's needs), and matching based on machine learning (such as by feeding the inputs of previous selections and the outcomes as rated by consumers, the host, or both into a neural network or other machine learning engine that, over time, refines a machine-based selection (or routing) of particular consumers to particular service providers based on a wide range of input factors of the type described throughout this disclosure).

In embodiments, the host system 100 may have visibility into a service provider's schedule and current location, allowing the host to do a real-time dispatch to a customer. Such real-time dispatching may use the schedule and location as other criteria for selection.

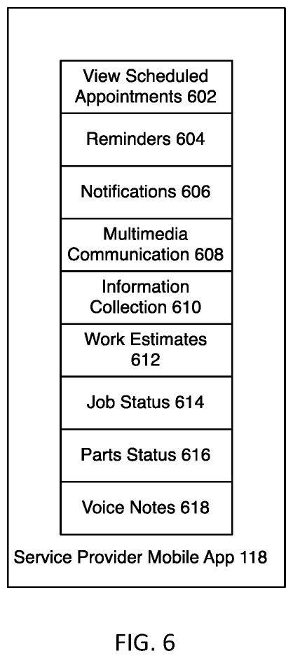

In embodiments, a service provider may access the service provider mobile application 118, which is a mobile application that may be accessed by a service provider owner, manager, or technician. Referring to FIG. 6, users can view scheduled appointments 602. Servicers may do a triage call before going on-site with a customer in order to increase likelihood of having the appropriate part on the truck or to estimate time required on-site. The mobile application may provide reminders 604 to the technician to do the call, initiate a call, allow the technician to collect information from the call, order a part required, or the like. As customers often like to be notified before the service provider comes on-site, the mobile application 118 may be used by a technician to initiate notifications 606 such as a call to a consumer, for example thirty minutes before going on-site, may initiate a notification (e.g., mobile notification, text message, email) to the customer that the technician is thirty minutes before going on-site, or may provide GPS information to allow the consumer to see the technician on a map en-route, such as via a web application or mobile app that is distributed to the consumer. The mobile application 118 may be used by the technician or consumer to communicate photos or video of items, including ones relevant to problem through multimedia communication 608. For example, the mobile application 118 may communicate information such as photos, recorded video, or real-time video, such as of an item, how it is working, what modes are failing, what defects are present, or the like, such as to help a technician determine in advance the likely time required for work to be done or the parts likely to be required. Such photo, video, or real-time video interaction could be used by the host 100, or by a warranty provider or subscription company, to determine if work would be covered by a warranty or subscription (e.g., for claims adjudication). In embodiments, the mobile application 118 may be used by the technician, or by a consumer, to collect information about the systems and items through an information collection function 610, such as appliances, that are on-site at the home. Such information could be text based or could comprise photos that are interpreted manually, through software (including OCR software) or through a service like Mechanical Turk™. The mobile application 118 may be used by the technician to generate work estimates 612 that estimate the work needed to be done after an on-site diagnosis. Such an estimate may be presented to the consumer on the technician's mobile app 118 or via a separate consumer user interface, such as of a consumer mobile app, and then the consumer can accept or decline the work to be done via pushing a button or executing a signature on the mobile device. The mobile application 118 may be used by the technician to indicate if the job is complete or if another visit is required through a job status function 614. The mobile app 118 may be used by the technician to record if the technician has picked up or dropped off a part at a local parts distributor through a parts status function 616. The mobile application 118 may be used by the technician to audio record a voice note 618 as to what work was done, rather than requiring the technician to type or write such information.

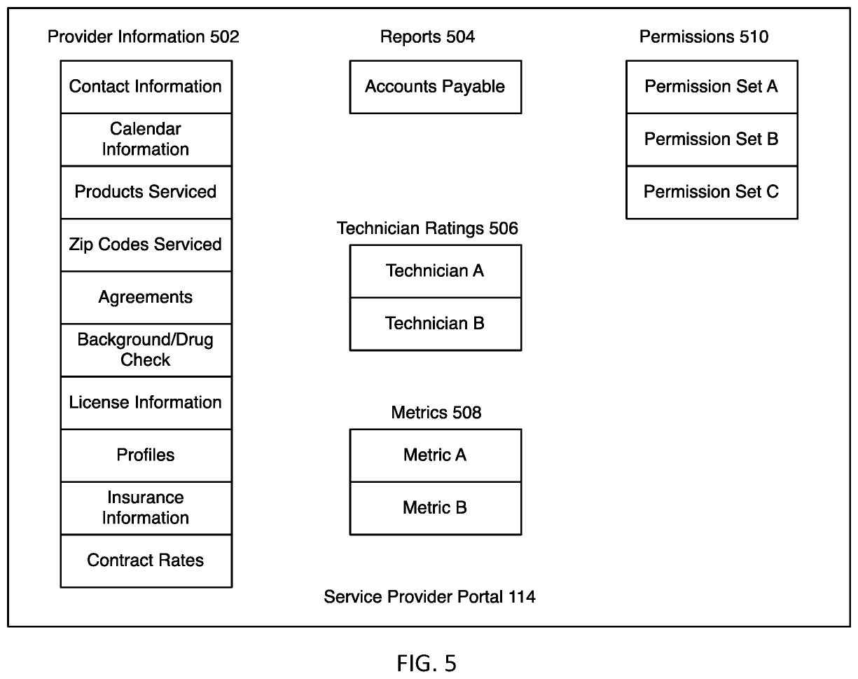

Referring to FIG. 5, the service provider portal 114 may be provided to a service provider, whereby the service provider may enter provider information 502. Provider information 502 may include contact information, calendar information (such as relating to availability), products serviced (brands and types of products), zip codes serviced, profile(s) for consumers to view (which may include information on one or more technicians, optionally including one or more photos of the technician, as well as information about which products and brands the technician services), a click-wrap of the agreement between the service provider and the host, background check and/or drug check information, license information, insurance certificate/information (optionally via upload and including possible visual inspection by on-demand/subscription company or third party service, which may include something like Mechanical Turk™), agreed upon contract rates and the like. The portal 114 may include reports 504 on accounts payable to the service provider. The portal 114 may solicit and collect technician ratings 506 to help a service provider understand the quality of its workers, which may be segmented by different types of work (e.g., a technician may be better at working on one brand of appliance versus another). The portal 114 may include any other metrics 508 used by a company to determine which jobs get sent to that particular service provider or technician. In embodiments the system 100, including the portal 114 or the mobile application 118, may facilitate user-level permissions 510, such as having different views on the data by different service providers, owners, managers, and technicians. In embodiments the host system 100 may communicate, via the portal 114 or application 118 how a service providers metrics (including cost and quality) compare to other service providers.

In some cases, homeowners are more likely to be interested in a subscription for home maintenance and repair services at particular times, such as when they buy the home, on or near anniversaries purchase of particular items (such as when warranties tend to expire), or when they have problems with the home. The host may solicit information from service providers, such as obtaining information on homeowners that have recently gone through a repair, even if the host system 100 is not involved, in order to market to such consumers. The service providers may be paid for such information, which may include a flat fee or on a contingent basis (e.g., not paid unless a homeowner purchases a product). The host system 100 may track when such information was submitted and by whom, so that contingency-based payments could be made appropriately.

Knowing when a technician will be on-site at a customer will allow the host to dedicate service staff at those times, such as to ensure that the technician can get questions answered immediately (e.g., whether a claim is covered by a warranty or subscription) while on-site to reduce costs to the host and the technician by avoiding call hold times or repeat visits to the customer.

In embodiments, the host system 100 may compare the claims associated with one service provider versus others performing similar work, based on similar vectors (e.g., geography, systems and appliances, type of fix) to identify fraudulent claims or groups of claims.

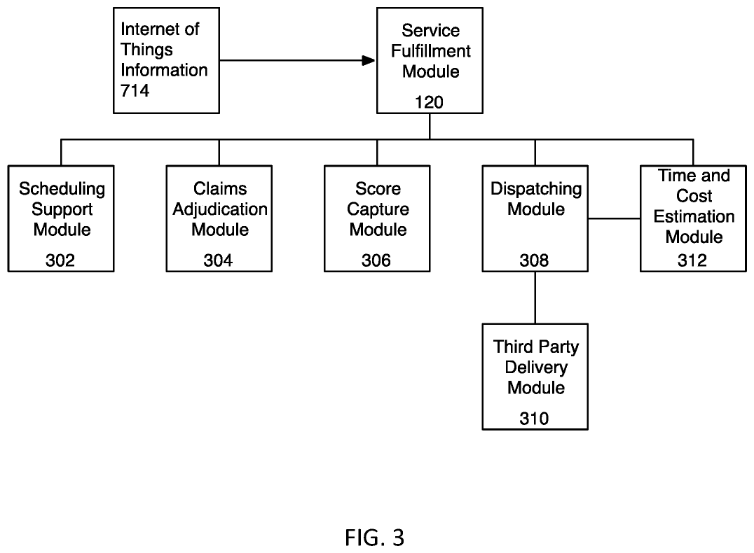

The modules of the host system 100 may include the service fulfillment module 120, which may have various sub-modules, components, features and functions. Referring to FIG. 3, the service fulfillment module 120 may provide real-time scheduling support through a scheduling support module 302. Integration with service provider scheduling systems is challenging, because there are not standard systems in the industry for service providers to manage their schedules. Therefore, the host system 100 may have the service provider enter availability into an online system. Alternatively, the host wishing to schedule the service provider may manage inventory of available spots based on information provided by the service provider. Inventory of availability may be specific to the geography, because a service provider may have different technicians that may cover different geographic regions at different times of day or different days of the week. Inventory of availability may be configured to expire, such as by a certain duration before the appointment window (e.g., before a 2:00 pm deadline in order to schedule an appointment for the following day).

The service fulfillment module 120 may facilitate claims adjudication through a claims adjudication module 304, such by soliciting information, such as through a series of questions, to help determine if a claim is covered or not. The service fulfillment module 120 may capture a score through a score capture module 306, such as a net promoter score (NPS), which may be either an overall score or a score for a particular component of the service provider's services. For example, a consumer may enter a ranking for the service experience, indicating their level of satisfaction. This may be captured, for example, via email, text message, mobile application, or website (PC/mobile).

The service fulfillment module 120 may also include facilities for dispatching through a dispatching module 308, such as dispatching a parts distributor. For example, the system 100 may allow for tracking what parts are needed by technicians in what locations, for tracking which parts have been ordered, picked up, dropped off, returned, or the like, and for tracking what payments are required and have been made. In embodiments, the service fulfillment module 120 or the system 100 more generally may integrate with a third party delivery service through a third party delivery module 310, such as for parts delivery. A mobile application, such as the mobile application 118 may be used to coordinate drivers who deliver parts.

The service fulfillment module 120 may facilitate time and cost estimation through a time and cost estimation module 312, such as by soliciting estimated times and prices from service providers. Over time, with more dispatch data, the system 100 may estimate the time and cost of work based on analysis of historical transactions and other data. This estimation may be based on the information provided by the consumer (e.g., make, model, problem, geography). This estimation may be based on the information provided by the technician after a triage call in advance of an on-site visit. This estimation may be based on information entered by the technician after the on-site diagnosis.

The service fulfillment module 120 may also facilitate improved scheduling. Even if the host system 100 does not control the scheduling system of the service provider, the greater share of the schedule the host system 100 handles (by virtue of handling large number of service requests), the more control the host system 100 obtains over scheduling with respect to a given service provider. Normally, a servicer might schedule, for example, four appointments in each of two (or possibly three) windows per day. Where the host system 100 is permitted to schedule the first appointment of the window, it can determine if an actual appointment time has an effect on customer satisfaction. If the host system 100 schedules most or all of the appointments within a window, it can determine the most efficient routing, and it can use time estimation to reduce the appointment window (or provide an actual appointment time) for a consumer.

In embodiments, the host of the host system 100 may encourage others to help recruit consumers to use the system; for example, the host may pay commissions to those who sell subscriptions to others. People receiving commissions may include real estate agents (standard in industry today in 49 states), indirect distribution partners (e.g., real estate, insurance, title, mortgage companies), service providers (uncommon, but done by companies that directly employ their workers), or homeowners. For example, such homeowners could recruit other homeowners to sell and get further commissioned on the sales of those other homeowners they recruit. Commissions may be linked to premium levels or profitability to encourage selling to better consumers and avoiding bad risk. Commission programs could be reduced or eliminated in cases that turn out to involve selling too much bad risk.

In embodiments, the host may perform a lightweight or heavyweight inspection, done by an employee, third party, or by the consumer, and the host may collect a list of maintenance and/or repair work required to be done. The task list of things to be done may be available online to the consumer. The host may use such inspection data for the purposes of pricing a subscription product or recommending pricing, and/or implementing a maintenance program.

In embodiments, the system 100 may involve integration with the Internet of Things (IoT), such as with various Internet of Things devices in the home, including thermostats, lightbulbs, or internet-enabled HVAC systems. Referring to FIG. 7, IoT information 714 may be used as a source of information for the host system 102, including the scoring module 100. Referring to FIG. 3, such IoT information 714 may also alert the host to a required maintenance or repair. Such IoT integrations may indicate a service record used for pricing product, predicting costs, or recommending a maintenance program. Such IoT integrations may be indicative of maintenance behaviors (e.g., if the efficiency indicated by a smart thermostat by the time required to heat/cool a space comparable to other homes may indicate lack of filter replacement).

The modules of the host system 100 may further include a consumer communication module 122, which may include an element scheduling module 128, a cost estimator module 130, a gamification module 132 and/or a homeowner coordination module 134, one or more of which may populate information accessed by a consumer, such as through a consumer user interface 138, which might be embodied in a web page for access by a browser, or provided via a mobile application, which might be the same as the service provider mobile application 118, or a distinct application directed just to consumers, such as homeowners.

Regular emails with consumers have been shown to increase renewals significantly for those who do not have a breakdown or similar problem that requires repairs (and therefore do not have a service experience). Additional engagement beyond email can increase renewals further. The host of the system 100 may have an inspection/maintenance schedule for a home, similar to a maintenance schedule a mechanic recommends for a car. The host may communicate maintenance or inspection elements on a regular basis to consumers, such as using the element scheduling module 128. Consumers would have a choice to perform maintenance themselves, not do it, or have a professional, such as service provider through the system 100, do the work for them. A challenge is that many of these maintenance and inspection elements do not require much time, and it can be expensive to have a service provider go on-site. For example, service providers may commonly charge $150 per visit for a minimum of one hour's time. Approximately $85 of that $150 may comprise the cost of sending the technician from the previous location to the next location. In embodiments, the host of the system 100 could offer a homeowner brief maintenance work (such as inspection of a clothes dryer's air flow) to be done for $150, or only $75 each if they get a neighbor to join for the same time, $50 for 2 other neighbors, etc. Thus, a homeowner coordination module 160 may increase frequency of engagement, lower customer acquisition costs, lower cost of maintenance, and lower loss ratios on claims. In embodiments, consumers can send an email (if they have one) for a neighbor, select neighbors on a map (who may be subscribers, may not be subscribers, or have not already done such maintenance) to have a personalized postcard sent, or print a flyer/door-hanger to deliver directly. Such regular maintenance reminders may include estimated future cost of maintenance and/or repair for not doing such maintenance work. A cost estimator module 162 may be specific to the homeowner, such as based on the systems and appliances in the home. The host may create a point system and rankings to “gamify” such maintenance behaviors, such as using a gamification module 164. The host may show homeowners their performance compared to their neighbors, friends, or generally other similar homeowners. The gamification module 164 may provide increasingly difficult challenges before a consumer achieves major milestones, such as to encourage usage by homeowners to reach the next milestone. The gamification module may include or interact with a loyalty or points system, such as one in which increased usage results in discounts, free services, improved commissions, or achievement of special levels of service.

The consumer user interface may include a service provider rating module 124, which may facilitate taking input from consumers about particular service providers (such as on time arrival, quality of work, friendliness and the like), which may be used as input to the service provider scoring module 104.

The system 100 may also include a pricing module 140, which may comprise a multi-vector pricing module, which may ingest, clean, normalize, process and analyze information about items, information about service providers, information about other factors (such as macroeconomic data) and the like and may include facilities for analyzing various factors that affect the ability to estimate costs and set prices for subscriptions, such as loss ratios, administrative costs, the lifetime value of a consumer subscription of a given type, renewal rates and the like. The pricing module 140 may include a pricing analysis module 142, which may include or work in coordination with a price sensitivity threshold module 144. Today, providers of home maintenance and repair contracts typically offer products with prices based on three vectors only: zip code, age of home, and a binary size metric as to whether the covered home is above or below a size threshold, such as 5000 square feet. Commonly, those vectors are used for pricing offerings that are pre-configured (e.g., the consumer is offered no choice in per-incident deductible (or “Service Fee”)), category limit (e.g., no more than $1500 of claims would be allowed for the refrigerator), and offering type (e.g., appliance only, appliances and systems, or a premium offering that removes exclusions in less expensive offering levels). This is due in part to historical limits on available information, which is spread across many different data sources, difficulty integrating the available data sources, challenges in understanding the relevance of particular data and the like. The present system 100 solves a number of those challenges and enables use of many more vectors to determine costs, and in turn many more vectors to set pricing. In addition, this enables a much wider, and more customized, set of offerings for consumers. Vectors that impact how a host prices offerings, such as based on expected loss ratios, administrative costs, lifetime value (“LTV”), and renewal rates, may include payment timing (e.g., monthly versus annual payment selection); the service provider ranking of the consumer by service provider 210; various real estate data elements (including without limitation any real estate data element one may extract from real estate sites such as Trulia™, Zillow™, Redfin™ and the like, or from sites of commercial real estate operations, such as property size, estimated property value, number and types of rooms, types of utilities, precise map location, and images of the exterior or interior of a property, including images that may show items that would be covered by a policy); and any of various digital advertising targeting data elements (including, without limitation, any of the data elements tracked and/or supplied by advertising data providers such as Datalogix™ or Neustar™, such as data (e.g., transaction data, purchase data, survey response data, online behavior data, viewing data, demographic data, location data and the like) that is used by such providers to determine whether a particular household or individual is likely to exhibit a particular characteristic or belong in a particular demographic, psychographic, or similar segment). For example, customers identified by advertising providers as customers of Mercedes®, BMW® or other high end automotive brands that typically have comprehensive, long term service plans, may be attracted to more comprehensive versions of maintenance and repair offerings, may have higher end appliances and the like, which information may be used to customize offers, set prices and the like. Other vectors that may be used include information about the systems and appliances inside the home (e.g., the make, model, age, manufacture date, installation date, service date and the like, as well as ratings from third party sources about those items, such as data from Consumer Reports® or similar sources about repair history); information about maintenance behaviors, including as indicated by the advertising segmentation data noted above; information about usage behaviors, including as indicated by the advertising data noted above; information about the type of utilities and systems in the home (e.g., type of heating, type of plumbing in the home (e.g., homes before mid-1970s are more likely to have copper plumbing versus PVC pipes), type of air conditioning system, sources of fuel (e.g. gas versus electric), and the like); location (which may be state, county, city, zip, neighborhood or more granular location; and water provider or type (e.g., some water districts have different water profiles (e.g., hard versus soft, basic versus acidic and the like). For example, different water profiles can have different effects on plumbing/water systems in the home. This feature would use a listing of homes, their water provider, and understanding of the water profile.

Other vectors may include the presence of a pre-existing condition. Pre-existing condition information may not be generally available, but the host may perform spot checks and correlate to various data signals, such as to seek indicators of the likelihood of preexisting conditions. For example, the age of items, the consumer's income or network may be indicative of the likelihood of a preexisting condition, as may other information, such as information indicating that the consumer has recently shopped for, but not purchased, an item for which the consumer is seeking coverage, which may indicate a defect or poor quality in the covered item. In embodiments the host may mandate a lightweight or heavyweight inspection for the home and aggregate such inspection data in a database to provide insight as to how certain inspection data leads to claims or conditions that drive costs. The host may also collect photos from consumers that may be indicative of preexisting conditions.

Other factors that may be considered may include the size of the home, such as on a sliding scale, as well as public data related to renovations done on the home (e.g., a 1920s home could have had plumbing redone very recently whereby the plumbing risk is much lower; such work may be detailed in public records on file when permits were requested).

In embodiments, the host system 100 may integrate with the systems of home inspectors to collect pre-existing conditions, required repairs/maintenance recommendations and the like, which may be used as factors in pricing and cost estimation, among other things.

In embodiments, the host system 100 may determine price sensitivity thresholds, such as using a price sensitivity threshold module 144, such as to determine the optimal price based on some or all of the factors/vectors noted above and elsewhere throughout this disclosure. Such price sensitivity thresholds may vary prices presented to different consumers along different vectors to maximize revenue (and thereby revenue growth), gross margin, EBITDA, or the like.

Using a pricing analysis module 140, the host may analyze the effects that various factors/vectors noted above and throughout this disclosure are likely to have on various outcome vectors (e.g., expected loss ratios, administrative costs, long term value (LTV) of a consumer subscription, renewal rates, service provider ranking of consumers, and the like). The host may invest more in acquiring customers with positive input vectors, which may mean providing price discounts or incentives to acquire better customers.

In embodiments, the system 100 may support coupon usage. A coupon code may be used by a homeowner to get a discount on an on-demand or subscription product. Such a coupon code may be a flat amount, percentage, or offer for a free gift (e.g., HVAC filter, home service). The presence of coupons may be considered in the pricing analysis module 140 in determining its impact on the various outcome vectors noted above.

To obtain data about items, such as systems, appliances and the like, for use by various modules noted herein, including the pricing module 140, various sources 200 can be used. This may include information from an advertising technology company 202 that has placed cookies on one or more devices of the user when the user has visited a page (such as an owner's manual for an appliance) relating to the product. Also, item data may come from third parties who collect the data as a part of other services, such as real estate services 204, such as home inspections, appraisal services, real estate brokerage services, and the like. Item data may also come from search engine optimization (SEO) and cookie data, such as from having observed users visiting a webpage containing content on such a system or appliance (e.g., owner manual). The data may also come from transaction data of a supplier of one or more items, or a financial services company 208 or similar provider that has transaction records for use of credit cards, debit cards and the like. Item data about systems, appliances and the like may also come from a consumer 206, who could be provided a discount or other incentive for providing such information. The data could be extracted from photographs or videos of a consumer's home, such as taken to document the items that will be covered. Such extraction may be accomplished in embodiments by automated extraction of relevant data, such as logos, model numbers, and the like that help identify a make, model and type of item. The pricing module 140 may also take IoT information 714 from the Internet of Things, such as information indicating the type and operating condition of a particular item, such as published by the item itself, either directly to the host system 100 or to one of the other data sources used as scoring data sources 162 or pricing data sources 200. The pricing module may also take information from the various scoring data sources 162, including inferences generated by the inference engine 712 described elsewhere herein.

The pricing module 140 may have facilities for building new subscription services. For example, the system 100, such as in cooperation with the pricing module 140, may calculate the cost and price of new subscription services based on frequency and cost of services provided to consumers outside of existing subscription services. The elements of a price/cost calculation may be segmented and calculated for any of the input vectors above.

The host system 100 may further include a user registration module 148 and an account management module 150. The user registration module 148 may solicit basic user information, as well as information relating to one or more of the many vectors/factors noted above and throughout this disclosure. For example, a homeowner may be asked to enter information about location, home size, number and type of appliances and the like. The registration module 148 may facilitate selection of an offering (such as what type of coverage is desired and the desired payment structure) as well as entry of home address and billing address information, as well as payment information. The account management module may facilitate setting up billing, such as monthly or annual billing. The account management module may notify a consumer about upcoming renewals and allow changes to levels of offering. The account management module may also facilitate making payments to service providers for completed work.

Enabled by the account management module 150, a user of the module 150 may view/edit various information, such as profile information, payment information, subscription information, upcoming dispatches, historical dispatches, payments made (including parts, labor (optionally including either retail or wholesale labor rates)), and what portion of the payment (if any) was covered by the subscription. The account management module 150 may be used to schedule, cancel, reschedule jobs and to track the nature of the items in the home. In embodiments, the host system 100 may facilitate provision of various “concierge services,” such as coordination of services for a consumer with service providers. An online interface may allow a consumer to add, edit, view, or cancel such concierge services.

In embodiments, the host system 100 may facilitate collections, such as collecting payments that may have been made to servicers, retrieving funds from third party insurers covering risk and collecting funds from consumers for services not covered by the subscription but provided to the consumers.

The system 100 may maintain maintenance records. A maintenance record held by the host may be made available to the next owner of a home, so that the next homeowner knows when the next servicing is required. Such information is commonly lost in such transactions. A maintenance record held by the host may be made available to a prospective buyer of a home to help the seller facilitate a transaction with a buyer.

The account management module 150 may support credits for good behavior. Benefits may be offered for consumers with excellent maintenance records or little or no claims. Benefits may include increased caps, reduced copays, or free services.

In embodiments, the account management module 150 may support offerings for multiple properties. Consumers with rental properties or other secondary homes are highly likely to appreciate the services provided by the host. People who rent properties have predictable income and mortgage, but unpredictable maintenance and repair costs. The host may include features specifically for such homeowners, including keeping record of multiple properties, providing discounts for multiple properties, or providing interfaces to access information for different roles (e.g., renter, owner). Similarly, those caring for a senior citizen may require similar capabilities (e.g., allowing different roles for a financial caretaker versus a resident owner in the home).

In embodiments, the host system 100 may integrate with systems of insurers to provide information to help consumers qualify for discounts. For example, the host may check/adjust the water PSI going into the home and communicate such PSI to the insurer so that the insurer can determine the risk of pipes bursting.

The host system 100 may also include a bad faith detection module 152, which may include or coordinate with a property ownership change detection module 154. There are some customers that may seek to subscribe and then drop coverage after things get fixed. A waiting period, such as for thirty days (meaning no claims are covered within the first thirty days of acquiring coverage) may avoid some of this behavior, but is not likely to eliminate it completely. Companies today do not filter out customers that have previously acquired coverage and have immediately dropped coverage after getting something fixed. Some of these customers may even go so far as to change their name on a policy with the same address, or naming another person in the same household, to avoid detection. The host system 100 may, via bad faith detection module 152 and process, check to see if the ownership of the property has changed hands, such as using a Property Ownership Change Detection Module 154 that inspects relevant real estate records in public databases. If not, the host can raise the rates significantly or refuse to cover the customer to make sure it is not offering subscriptions at a loss.

For those areas where the host does not charge for services on a subscription basis, the host system 100, such as using the pricing analysis module 140, can provide services on an on-demand basis to begin to understand the risk associated with such costs. The host can then create subscription packages to cover such costs. Similarly, based on claims history, the host system 100 can help homeowners understand the failure likelihood and estimated costs associated with their homes. These estimates become more accurate the more data the host system can access about the home.

Embodiments may also facilitate on demand provision of maintenance or repair services. In such cases the system 100 may collect the make and model of a system, appliance, or other item, such as by having the consumer enter the information, along with a zip code and problem description to initiate a flow. The system 100 may provide for real-time scheduling of a service provider, collect address of the customer, collect payment information of the customer and/or confirm appointment time.

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platform. A processor may be any kind of computational or processing device capable of executing program instructions, codes, binary instructions and the like. The processor may be or may include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server, and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

The method steps of the implementations described herein are intended to include any suitable method of causing such method steps to be performed, consistent with the patentability of the following claims, unless a different meaning is expressly provided or otherwise clear from the context. So for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

What is claimed is:

1. An information technology system for enabling a host to facilitate provision of home maintenance and repair services to a consumer, comprising:
an item scoring module for scoring at least one item based on its type, the score based at least in part on a probability of a need for maintenance or repair and an estimated cost of such maintenance or repair;
a service provider scoring module for scoring at least one service provider based on at least one of a quality of maintenance or repairs provided by the service provider, an availability of the service provider, a reliability of the service provider and a cost of the service provider; and
a pricing module for estimating a cost of providing a commitment to provide long term maintenance and repairs for the at least one scored item using at least one scored service provider.

2. The system of claim 1, wherein the pricing module includes a facility for determining at least one of a loss ratio, an administrative cost, a lifetime value, and a renewal rate.

3. The system of claim 1, wherein the pricing module includes a pricing analysis module.

4. The system of claim 1 further comprising a consumer communication module.

5. The system of claim 4, wherein the consumer communication module includes at least one of a scheduling module, a cost estimation module, a gamification module, and a coordination module.

6. The system of claim 1 further comprising a service fulfillment module.

7. The system of claim 6, wherein the service fulfillment module selects a service provider for fulfillment based at least in part on the service provider scoring module.

8. The system of claim 1 further comprising a bad faith detection module for determining bad faith behavior by at least one of a consumer and a service provider.

9. The system of claim 1 further comprising a service provider portal for facilitating interaction of a service provider with the system.

10. The system of claim 9, wherein the service provider portal facilitates a provision of information to a servicer mobile application that provides information about repair or maintenance activities for a service provider with respect to at least one item of at least one consumer.
